(19) United States
(12) Patent Application Publication
(10) Pub. No.: US 2026/0343711 A1
(43) Pub. Date: Oct. 29, 2026

(54) METHOD FOR SITUATION-BASED ACTUATION OF LIGHTING ALONG A ROAD

(71) Applicant: VOLKSWAGEN AKTIENGESELLSCHAFT, Wolfsburg (DE)

(72) Inventors: Hendrik Hoppmann, Braunschweig (DE); Janis Köstermann, Berlin (DE); Gerd Penshorn, Edemissen (DE)

(21) Appl. No.: 19/116,199

(22) PCT Filed: Oct. 2, 2023
(86) PCT No.: PCT/EP2023/077195

§ 371 Date: Mar. 27, 2025

(30) Foreign Application Priority Data
Oct. 6, 2022 (DE) 10 2022 210 558.3

(51) Int. Cl. H05B 47/155; H04W 4/44; H05B 47/115; H05B 47/175; H05B 47/19

(52) U.S. Cl. CPC H05B 47/155; H04W 4/44; H05B 47/115; H05B 47/19; H05B 47/196

(57) ABSTRACT

A system and method for situation-based activation of road lighting involve a group of street lighting devices, where at least one device includes a Car2X module. This module receives information from an approaching vehicle equipped with a similar Car2X module. Based on the transmitted information, the lighting of each street lighting device in the group is individually adapted. The approaching vehicle provides data from its surroundings monitoring system to the Car2X-equipped street lighting device, enabling the lighting to be tailored to road users or objects lacking Car2X modules. Adjustments account for detected conditions, enhancing visibility and safety along the road.

### RELATED APPLICATIONS

The present application claims priority to International Patent Application No. PCT/EP2023/077195 to Hoppmann et al., filed Oct. 2, 2023, which claims priority from German Patent App. No. DE 10 2022 210 558.3, filed Oct. 6, 2022, the contents of each being incorporated by reference in their entirety herein.

### TECHNICAL FIELD

The present disclosure relates to technologies and techniques for the situation-based activation of lighting along a road, in which at least one street lighting device in a group of street lighting devices is equipped with a Car2X module and receives information from an approaching vehicle and, based on the transmitted information, the lighting of each of the street lighting devices within the group is adapted as needed. In the process, especially information detected by the approaching vehicle via the surroundings monitoring system thereof, is transmitted to the street lighting device equipped with a Car2X module so that the lighting of the street lighting devices within the group can be individually adapted to road users and/or objects not equipped with a Car2X module.

### BACKGROUND

The development of interconnected driving is continually advancing and, amongst others, is aimed at also including the urban infrastructure in the interconnectedness. This includes the illumination of roads or traffic management devices, such as traffic lights.

Interconnectedness offers high potential, especially for street lighting, since interconnectedness would enable intelligent and demand-based activation that, on the one hand, can significantly lower the energy consumption and thus also the CO2 footprint for street lighting and, on the other hand, could mitigate so-called light pollution, in particular in the inner-city area. Additionally, an adaptation to various situation-dependent lighting needs would be conceivable.

Several solutions have already been proposed in the prior art. For example, DE 10 2013 002 876 B 3 shows a method for operating street lighting, wherein route data describing the further course of the road user along the road are received via a communication link between at least one road user and a communication device assigned to a light source, and the light sources are switched from the basic state to the illuminated state based on the route data.

U.S. Pat. No. 9,706,624 B 2 discloses a lighting method and system and a street lamp. The lighting of the street lamp is only activated when a vehicle is located in the illumination range of the street lamp. For this purpose, the street lamp is equipped with a communication module to which trip information (longitudes and latitudes) is transmitted from the vehicle.

DE 10 2017 205 075 A 1 relates to a method for controlling infrastructure lighting from a vehicle, in which wireless communication exists between the vehicle and at least one light source (in particular a street lighting device) of the infrastructure lighting system, and at least one device of the vehicle is functionally linked to the infrastructure lighting system. When the vehicle approaches, the street lighting device is switched on when the vehicle is at a certain distance, optionally taking the further driving route of the vehicle into consideration.

However, none of the previously known solutions takes into consideration that far from all road users can participate in the communication among road users (Car2Car) and with the surroundings (Car2X) and may potentially also not be able to do so in the future. This includes not just vehicles or road users that do not have the appropriate equipment, but also pedestrians, bicyclists and the like.

US 2020/0170093 A1 and EP 3770488 A1 show methods in which lighting is adapted based on data detected by street lighting devices. The drawback here is the technical complexity for equipping the street lighting devices and the deviation of the perspective during data detection from that of the vehicle driver.

### SUMMARY

Aspects of the present disclosure are directed to providing technologies and techniques for adapting street lighting in which in particular road users and/or objects that do not participate in the interconnectedness are taken into consideration.

According to some aspects of the present disclosure, the described functionalities are achieved by the independent claims of the present application, as detailed below. Additional aspects are disclosed in the dependent claims, the description, and the drawings.

In some examples, a method, system and computer program pruduct are disclosed for the situation-based activation of lighting along a road, at least one street lighting device in a group of street lighting devices along the road receives information from at least one approaching vehicle, equipped with a Car2X module, by means of a Car2X module and, based on the transmitted information, adapts the lighting of each of the street lighting devices in the group of street lighting devices as needed, wherein the at least one approaching vehicle transmits information detected by means of the surroundings monitoring system thereof to the at least one street lighting device comprising a Car2X module, so that the lighting of each of the street lighting devices in the group of street lighting devices is to be adapted or can be adapted to road users and/or objects not equipped with Car2X modules.

The various specific embodiments described in the present application can advantageously be combined with one another, unless they are implemented differently in the individual case.

### BRIEF DESCRIPTION OF THE DRAWINGS

Aspects of the present disclosure will be described hereafter in exemplary embodiments based on the associated drawings. In the drawings:

FIG. 1 shows a first exemplary application of the method according to some aspects of the present disclosure; and

FIGS. 2, 3, 4 show further exemplary applications of the method according to some aspects of the present disclosure.

### DETAILED DESCRIPTION

As disclosed in various examples herein, a plurality of street lighting devices provides illumination for a road. This encompasses all lighting devices that illuminate the road or traffic space, including standing lamps (commonly referred to as street lamps) and hanging lamps mounted on buildings or similar structures. These street lighting devices can illuminate traffic spaces in urban areas, rural areas, tunnels, and various other traffic zones.

In some examples, the present disclosure includes controlling or adapting street lighting devices in groups. A group of street lighting devices may, for example, include those along a road segment between two intersections or within a defined route. Such a group may encompass devices on both sides of the road or only on one side. Other groupings are also contemplated within the scope of the present disclosure. In all cases, a group comprises at least two street lighting devices controlled based on the same input data, organized in a meaningful relationship for this purpose. For improved readability, this is hereafter referred to simply as the “group.”

Within a group, at least one street lighting device is equipped with a Car2X module to receive information. Alternatively, multiple street lighting devices in the group may be similarly equipped to enable more precise activation of the lighting.

The present disclosure imposes no limitation on the technology used for Car2X modules. Suitable options include Cellular V2X (C-V2X), Dedicated Short Range Communication (DSRC), or other online-based solutions. DSRC facilitates vehicle-to-vehicle communication, independent of driver involvement, using semi-passive transponder technology with a limited communication range. In contrast, C-V2X leverages mobile communication networks for broader connectivity.

In some examples, the present disclosure enables at least one street lighting device equipped with a Car2X module to receive information from at least one approaching vehicle also equipped with a Car2X module. Interconnected vehicles continuously transmit status information to their surroundings, which recipients such as other road users or infrastructure devices can receive, evaluate, and utilize. This information typically includes the vehicle's current position, speed, driving direction, and, where available, planned driving route. As established in the prior art, this enables a street lighting device to activate when a vehicle approaches and deactivate once the vehicle exits the illumination zone. Additionally, this allows timely illumination of a secondary road the vehicle intends to enter, serving both to guide the driver and to alert other road users, such as pedestrians, of the approaching vehicle. The light color, intensity, or animation (e.g., flashing or pulsating) may also be adjusted. Each street lighting device within the group can be individually activated and adapted.

Accordingly, the information transmitted to the at least one street lighting device with a Car2X module enables individual activation of each street lighting device within the associated group. This control may be managed by a control unit within the Car2X-equipped street lighting device, functioning as a central intelligence unit. Alternatively, control may originate from a separate location, such as a secure, protected site near the group where a control device communicates with the street lighting devices. The control unit could also reside in a remote location, including an online or cloud-based solution. In such cases, a stable communication link is required between the Car2X-equipped street lighting device and the control device, as well as between the control device and the other street lighting devices, to transmit control signals for lighting adaptation.

The present disclosure also incorporates additional information from the at least one approaching vehicle—specifically, data from its surroundings monitoring system—to adapt the street lighting for road users and/or objects lacking Car2X modules.

Modern vehicles are equipped with multiple sensors for monitoring their immediate surroundings. These sensors detect parameters such as temperature, precipitation (e.g., rain or snow), and the presence and relative positions of other road users or objects. Such surroundings monitoring enables the detection and recognition of non-interconnected road users and/or objects, for example, through camera, LIDAR, or radar systems paired with downstream evaluation within the vehicle.

The data collected is transmitted to a street lighting device equipped with a Car2X module, providing a broader foundation for adapting the street lighting to account for non-interconnected road users and/or objects. Non-interconnected road users include pedestrians, bicyclists, users of seated or standing scooters, and drivers of older vehicles without Car2X modules. Non-interconnected objects may include parked bicycles, scooters, or other traffic-impeding items, such as cargo fallen from a vehicle or toppled trees. The use of plural terms herein indicates that at least one road user and/or at least one object without a Car2X module is considered in the lighting adaptation.

Adapting the lighting for non-interconnected road users and/or objects involves illuminating their movement paths or positions to ensure safe travel and visibility. For non-interconnected objects, the lighting enhances visibility to alert approaching vehicles, thereby preventing accidents or damage. The accuracy and effectiveness of this adaptation increase as more interconnected vehicles transmit surroundings monitoring data to the Car2X-equipped street lighting device. These vehicles effectively serve as sensors for non-interconnected road users and/or objects, eliminating the need for dedicated sensor systems on the street lighting devices or active input (e.g., via mobile device applications) from such road users.

As a result, the present disclosure allows individual activation or deactivation of each street lighting device within the group as needed, with adjustments to brightness, light color, or other parameters. This benefits not only road users with Car2X modules but also those without, as well as non-interconnected objects. Such an interconnected system enhances accessibility for all road users without requiring complex retrofitting. It also reduces energy consumption and the CO2 footprint of street lighting while improving traffic safety for both interconnected and non-interconnected road users and objects.

In a first preferred embodiment, the surroundings monitoring system of the at least one approaching vehicle detects particularly vulnerable road users. The lighting of street lighting devices within the group, whose illuminated areas contain or intersect with the presence or movement of these particularly vulnerable road users, is adapted accordingly.

Particularly vulnerable road users (VRUs), also known as unprotected road users, represent a subgroup of non-interconnected road users or those without Car2X modules. These individuals are at heightened risk of injury or death in traffic due to the absence of a protective enclosure, such as a vehicle body. This group includes pedestrians, bicyclists, and motorcyclists. The objective of this embodiment is to enhance the safety of these particularly vulnerable road users through tailored street lighting adjustments.

For this purpose, the present disclosure enables detection and recognition of particularly vulnerable road users (VRUs) through the surroundings monitoring system of at least one approaching vehicle. This capability is typically present in vehicles of current design and may apply to one or more VRUs. Information about VRUs in the vicinity of the approaching vehicle is transmitted to the Car2X module of a street lighting device. The lighting of street lighting devices—whose illuminated areas cover the location or movement path of a VRU—can then be adjusted by an associated control device. Adjustments may include switching on the lighting, modifying brightness or light color, or similar changes to enhance the visibility of the VRU for other road users. When a VRU exits an illuminated area, the lighting of the corresponding street lighting device can be switched off or dimmed. This approach significantly reduces accident risks for VRUs while also lowering energy consumption. Additionally, improved illumination may enhance the personal safety perception of VRUs, not only in relation to surrounding traffic but also against potential attacks or assaults.

In some examples, VRUs may also participate in road traffic interconnectedness using dedicated sensor systems or mobile device applications. In such cases, the passive detection and protection described in the above embodiment may be unnecessary or serve only as a supplementary measure.

In a second embodiment, the present disclosure includes estimating the likely movement direction and/or speed of road users and/or objects not equipped with a Car2X module to adapt the lighting of street lighting devices within a group. This estimation may also apply to the aforementioned VRUs.

When detecting road users or objects without a Car2X module, the surroundings monitoring system of a vehicle generally captures their position and, if applicable, their current movement. If a road user or object is moving, the system can detect the movement direction and determine or estimate the movement speed. For instance, if a non-interconnected vehicle signals an impending turn via its turn indicator, this information can contribute to estimating its movement.

As described earlier, this information is transmitted to a street lighting device equipped with a Car2X module. The associated control device can then estimate the likely movement direction and/or speed based on the available data, particularly when multiple approaching vehicles detect the same non-interconnected road user or object. By combining movement direction and speed, the control device can calculate the future position of the road user or object, assuming no changes in direction or speed occur. However, since such changes cannot be ruled out, this calculation represents an estimation that can be refined or updated with additional data from other approaching vehicles or subsequent datasets from the same vehicle(s). Local conditions—such as nearby intersections, branching walkways, or building entrances—may also influence this estimation by suggesting potential changes in movement direction. In the absence of such features, the estimation may reliably assume that the movement direction is unlikely to change.

With knowledge of the likely movement direction and/or speed of a road user or object without a Car2X module, the lighting of street lighting devices can be adapted accordingly. This applies to devices whose illuminated areas currently contain, or will soon contain, the road user or object. Adjustments may involve switching on the lighting, altering brightness or light color, and switching off or dimming the lighting after the road user or object exits the illuminated area, as outlined previously.

This approach allows predictive illumination of a non-interconnected road user's movement path, enabling them to benefit from an interconnected street lighting system.

Simultaneously, it enhances their visibility to other road users.

Non-interconnected objects with a movement direction and/or speed may include items that move unintentionally, such as a falling tree branch or cargo dropped from a vehicle. In such cases, this embodiment enables the lighting to highlight potential hazards posed by uncontrolled moving objects, particularly by adjusting the light color in the affected illuminated area.

To further enhance the present disclosure, stationary road users equipped with a Car2X module can transmit information detected by their surroundings monitoring systems to at least one street lighting device with a Car2X module. This includes parked vehicles or those charging electric current. Even when stationary, such vehicles can use their surroundings monitoring systems to detect passing traffic, including non-interconnected road users, contributing to the adaptation of street lighting. Thus, stationary vehicles with Car2X modules function as sensors within the scope of the present disclosure.

To avoid unnecessary strain on energy resources, stationary vehicles may monitor their surroundings and transmit information intermittently rather than continuously-for example, in alternating patterns or specific time windows. This can also depend on their energy reserves, such as the charge state of an electric vehicle or the progress of its charging process.

The adaptation of street lighting can sometimes cause road users to experience glare. To mitigate this, the present disclosure enables adjusting the lighting of street lighting devices to reduce or prevent blinding, taking surroundings information into account. Glare from street lighting can be highly unpleasant and pose a safety hazard, particularly during rain or in very dark environments where bright lighting contrasts sharply with the surroundings. In this embodiment, surroundings information-regularly captured by a vehicle's surroundings monitoring system to support or ensure safe travel-can be transmitted and utilized. This information may include the presence and intensity of rain, snow, or fog, as well as ambient lighting conditions. From this data, the risk of glare from one or more street lighting devices in a group can be assessed, and their lighting adjusted accordingly, such as by reducing intensity. If no glare risk is present, the lighting remains unchanged.

In another embodiment, the present disclosure allows the lighting of street lighting devices within a group to be adapted to highlight a hazard area. A hazard area could be the site of an accident, a stranded vehicle, lost cargo, a fallen object, or similar situations. To prevent further incidents and assist first responders in locating the hazard, the lighting of street lighting devices illuminating the hazard area can be modified. Options include using colored light, pulsating or flashing patterns, or creating a “light corridor”—where the lighting of multiple devices is adjusted sequentially to guide attention toward the hazard area—serving as an effective warning or locator tool.

Hazard areas are identified, as described in prior embodiments, through the surroundings monitoring systems of interconnected vehicles. This can be supplemented by status information from a vehicle involved in an accident or stranded, provided it is equipped with a Car2X module.

In a further embodiment, the present disclosure enables at least one street lighting device with a Car2X module to relay transmitted information to an evaluation unit. This unit statistically analyzes the data to optimize the lighting adaptation of street lighting devices within the group.

The Car2X-equipped street lighting device connects to a control device (of any type) and forwards received information to an evaluation unit. This unit may be co-located with the control device or housed in the same system, though it can also operate independently.

The evaluation unit—potentially a simple processing device like a computer or a server-based application—performs statistical analysis on the transmitted information. This analysis can determine, for example, peak traffic density times when it may be impractical or unnecessary to switch off or dim street lighting between individual vehicles or road users. In such cases, continuous activation could extend the devices' lifespan by reducing switching cycles. The analysis can also account for factors like days of the week, school vacations, or holidays, allowing the lighting adaptation to be refined or optimized accordingly.

In some examples, the present disclosure benefits from the Car2X-equipped street lighting device receiving additional traffic-related information from an external data source. The lighting adaptation of the group's street lighting devices can then incorporate this data. Such information might include details about events or major occasions—e.g., concerts or soccer games—that increase traffic flow, or incidents like construction sites, accidents requiring first responders, or severe weather that affect nearby traffic. External data service providers, often online-based systems like weather services, can supply this information.

When such traffic-influencing event data is received, the street lighting can be adjusted to guide traffic via light corridors or, within permissible limits, use colors and pulsating light to enhance the area around or at the event site, preparing arriving visitors. For instance, the colors of a hosting soccer team could be used for an upcoming game. Alternatively, the lighting can be tailored to heighten road user attention, guiding large numbers of road users safely and efficiently. This might involve subtle flickering-imperceptible yet effective in subconsciously increasing observer awareness.

This embodiment can also apply to street lighting adaptations that do not specifically account for non-interconnected road users or data from approaching vehicles' surroundings monitoring systems.

To enhance driver comfort or perceived safety, the present disclosure allows the lighting of street lighting devices to be adjusted based on the lighting or geometry of an approaching vehicle.

Here, the light color and/or intensity of a street lighting device can align with the approaching vehicle's lighting as it passes through the illuminated area. This adjustment aims to improve route illumination for vehicle occupants, minimizing harsh light-shadow transitions and emphasizing safety-critical areas. This may require street lighting devices with matrix lighting—featuring multiple individually controllable light sources—to direct or focus the emitted light. The approaching vehicle must transmit details about its lighting (e.g., color, intensity, orientation) to the Car2X-equipped street lighting device.

Similarly, the vehicle's geometry-such as its classification as an SUV, sports car, or average-height vehicle-can be considered. A sports car driver sits lower than an SUV driver, affecting glare susceptibility. If the approaching vehicle transmits its type, geometry, or driver seat height to the Car2X-equipped street lighting device, the lighting intensity or orientation can be adjusted to reduce or prevent blinding as the vehicle moves through the illuminated area.

Beyond adapting to local traffic conditions, the present disclosure enables a Car2X-equipped street lighting device to relay transmitted information to other Car2X-equipped vehicles or to a street lighting device in another group.

This allows the Car2X-equipped street lighting device to share information—such as data on VRUs, hazard areas, or traffic status—with other interconnected road users.

Approaching drivers can thus receive early notifications and adjust their driving accordingly.

Alternatively or additionally, this information can be forwarded to other groups of street lighting devices, particularly adjacent ones. This is especially useful when a non-interconnected road user or object moves from one group's range into another, allowing the previously gathered data to be reused.

In some examples, the present disclosure can be implemented via a computer program product with instructions that, when executed by a computer, cause it to perform the described operations. This can also be realized as software or an application on a processing unit.

Implementing the present disclosure requires certain technical capabilities. Street lighting devices must be individually activatable and adjustable in light color and/or intensity. Some embodiments may necessitate matrix lighting, where multiple light sources can be controlled to direct or focus light.

Additionally, the described information must be available through interconnected vehicle systems, ensuring the Car2X-equipped street lighting device receives the necessary inputs.

Notably, most embodiments described herein can function independently of detecting non-interconnected road users or objects via approaching vehicles' surroundings monitoring systems, unless such detection is integral to the specific embodiment.

The present disclosure achieves its initial objective of adapting street lighting to non-interconnected road users and objects. This allows road users unable or unwilling to participate in interconnected driving to benefit without additional effort or equipment. Furthermore, need-based lighting adjustments save energy and reduce the CO2 footprint.

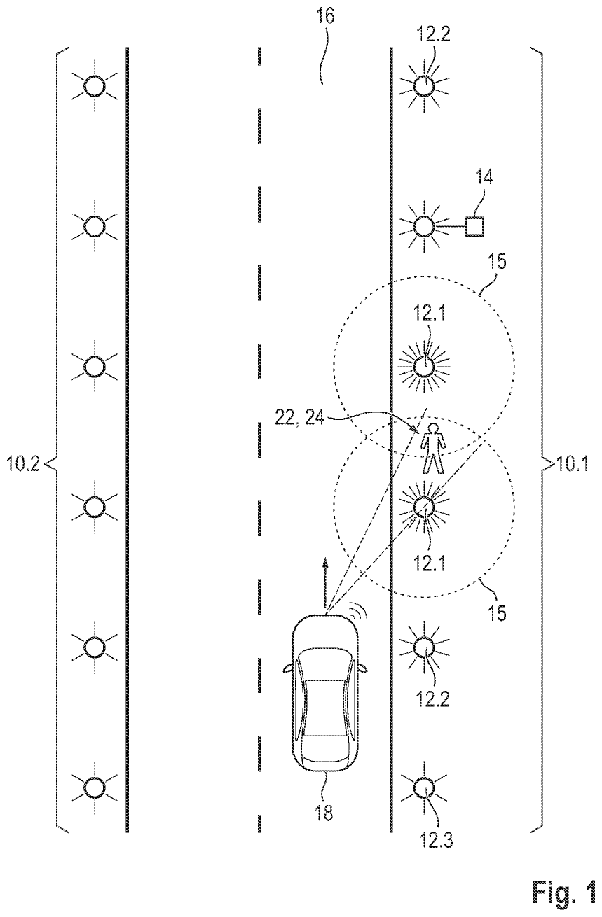

FIG. 1 shows a portion of a road on which a vehicle 18 comprising a Car2X module is traveling. The vehicle continuously emits status information, which can be received and evaluated by other road users comprising Car2X modules (not shown). Street lighting devices 12 are provided on both sides of the road 16, one of which (reference numeral 14) is equipped with a Car2X module. The street lamps on the left side of the road in the figure belong to one group 10.2 of street lighting devices, while those on the right side belong to another group 10.1. The situation-based activation of the lighting in group 10.1 will be explained based on FIG. 1. The street lighting devices of group 10.2 can be adapted in a similar manner.

As provided in the method according to the invention, the vehicle 18, with its surroundings monitoring system, detects ambient conditions and the situation in the immediate vicinity. This also includes the movement of a pedestrian 22, who is a particularly vulnerable road user 24. The pedestrian's position, movement direction, and movement speed can be determined by repeated detection within the scope of the surroundings monitoring process.

All the information is transmitted from the vehicle 18 to the street lighting device 14 equipped with a Car2X module. Based on this information, it can now be determined in which illuminated areas 15 the pedestrian 22, 24 is located or through which illuminated areas 15 he or she is traveling and at what speed. Accordingly, the lighting of these street lighting devices, highlighted here with 12.1, can be adapted so that the lighting in the surroundings of the pedestrian 22, 24 will be brighter than in the areas that he or she has already passed or will pass later (denoted by 12.2). Areas located at a sufficiently far distance from the pedestrian 22, 24 can be dimmed (denoted by 12.3), provided no other road user is present there. This evaluation of the transmitted information and the activation of the street lighting devices 12, 14 resulting from it are carried out by a processing device located on the street lighting device 14 equipped with a Car2X module, and take place in the form of a computer program.

Since there are no turns off the shown road 16, the further movement direction 28 and optionally the movement speed of the pedestrian 22, 24 can be estimated, allowing the street lighting devices 12, 14 to illuminate his or her path predictively. This does not affect the adaptation of the street lighting to the interconnected vehicle 18, which can be determined and activated simultaneously.

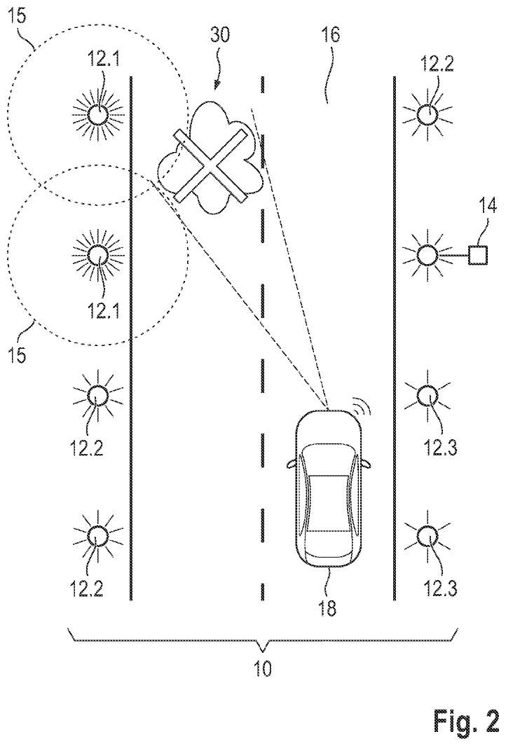

A second exemplary application of the method is shown in FIG. 2. The group 10 of street lighting devices 12, 14 is selected differently here; specifically, the street lighting devices 12, 14 on both sides of the road are part of one group 10. A vehicle 18 comprising a Car2X module detects its environment through a surroundings monitoring system, including the hazard area 30 where an accident has occurred. The vehicle 18 transmits this information via the Car2X module to the street lighting device 14 comprising a Car2X module. As a result, the street lighting devices 12.1, located in the illuminated area 15 where the hazard area 30 is situated, become especially bright and are illuminated with red light to indicate the hazard area. The adjacent street lighting devices 12.2 pulsate in bright light to warn approaching road users. The street lighting devices 12.3 are illuminated for the vehicle 18, without consideration of the hazard area 30. The street lighting device 14 can additionally transmit information regarding the hazard area 30 to a neighboring street lighting device comprising a Car2X module (shown in the figure above the hazard area 30) to enable adaptation of the street lighting in that area as well.

Instead of a hazard area 30 due to an accident, it is also possible for a non-interconnected object 26 to be standing or lying in this location, such as a double-parked vehicle or lost cargo from a vehicle.

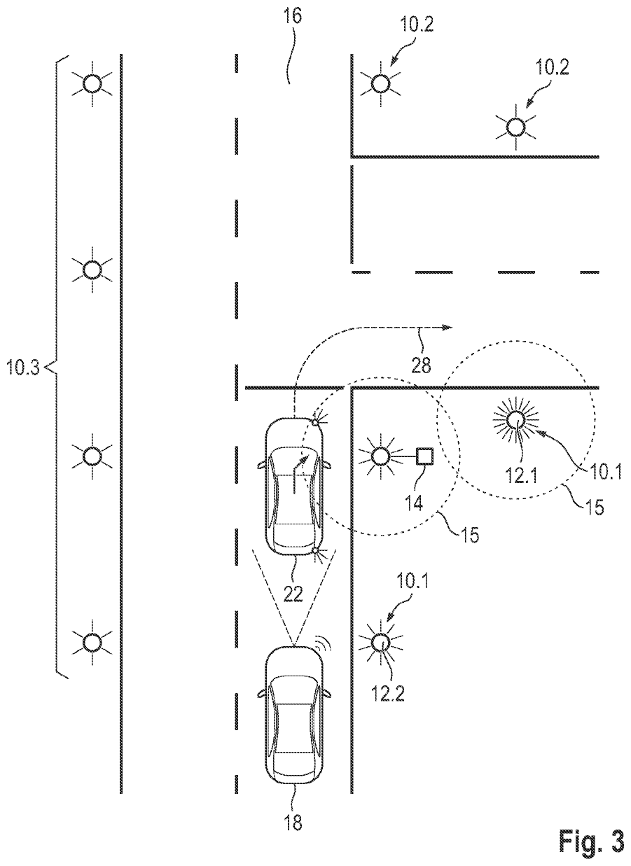

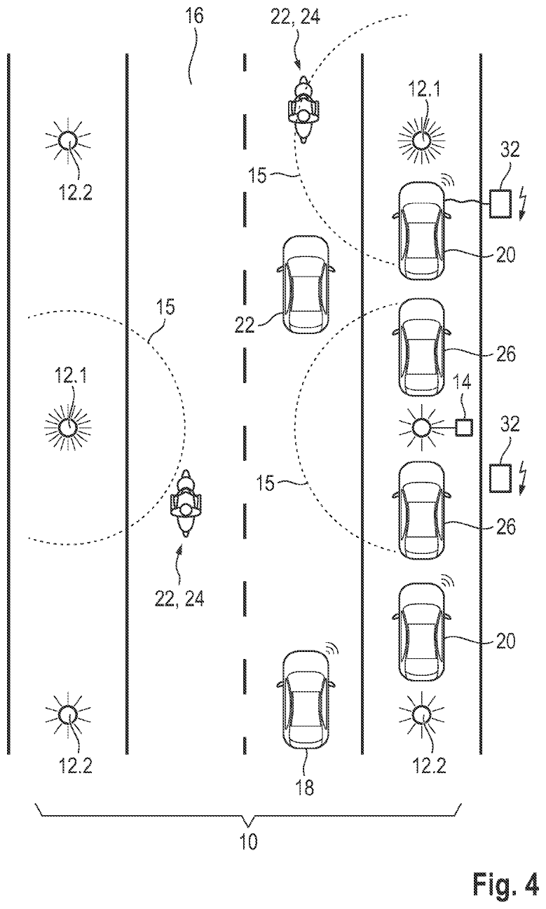

FIGS. 3 and 4 are structured similarly to FIGS. 1 and 2, so only the differences will be explained hereafter. The assignment of the reference numerals follows the same principles as in the preceding figures.

In FIG. 3, vehicle 18 detects vehicle 22, which lacks a Car2X module, stopped in front of it. Vehicle 22 is signaling to the right and intends to turn onto street 16. Thus, the likely movement direction 28 of vehicle 22 can be readily determined, allowing the street lighting devices 12.1 to be predictively switched on or set to a brighter light before the turning process of vehicle 22 is completed.

FIG. 4 shows road 16, which includes an adjacent parking lane featuring charging stations 32 for electric vehicles. All street lighting devices 12 and 14 in this area belong to one group 10. Both non-interconnected vehicles 26 and interconnected vehicles 20 are parked in the parking lane, some of which are coupled to charging stations 32. Charging vehicles 20 possess sufficient energy resources and detect their surroundings using their monitoring systems, transmitting this information to street lighting device 14. In this process, non-interconnected vehicles 26, as well as non-interconnected road users 22 and 24, which include motorcycles and seated scooters, are detected. Vehicles 20 that are not being charged can also monitor their surroundings at larger time intervals and send this information to street lighting devices 14. As previously explained with respect to FIG. 1, it is possible to determine which illuminated area 15 of the street lighting devices 12 and 14 the non-interconnected road users 22 and 24 are traveling through, allowing the lighting to be adapted—specifically, to be brightened as these road users pass and then dimmed when no further road users follow.

### LIST OF REFERENCE NUMERALS

10 group of street lighting devices
12 street lighting device
14 street lighting device comprising Car2X module
15 illuminated area
16 road
18 approaching vehicle comprising Car2X module
20 stationary vehicle comprising Car2X module
22 non-interconnected road user
24 particularly vulnerable road user (VRU)
26 non-interconnected object
28 likely movement direction
30 hazard area
32 charging station

1-11. (canceled)

12. A method for situation-based activation of lighting along a road, comprising:
receiving, by at least one street lighting device equipped with a Car2X module within a group of street lighting devices along the road, information from at least one approaching vehicle equipped with a Car2X module;
transmitting, by the at least one approaching vehicle, information detected by a surroundings monitoring system of the at least one approaching vehicle to the at least one street lighting device equipped with the Car2X module; and
adapting, based on the information received from the at least one approaching vehicle, the lighting of each street lighting device in the group individually to road users or objects not equipped with Car2X modules.

13. The method of claim 12, further comprising:
detecting, by the surroundings monitoring system of the at least one approaching vehicle, particularly vulnerable road users; and
adapting the lighting of street lighting devices in the group, whose illuminated areas contain or intersect with the presence or movement of the particularly vulnerable road users, to enhance visibility of the particularly vulnerable road users.

14. The method of claim 12, further comprising:
estimating, based on the information detected by the surroundings monitoring system of the at least one approaching vehicle, a likely movement direction or a likely movement speed of a road user or object not equipped with a Car2X module; and
adapting the lighting of the street lighting devices in the group based on the estimated likely movement direction or likely movement speed.

15. The method of claim 12, further comprising:
transmitting, by a stationary road user equipped with a Car2X module, information detected by a surroundings monitoring system of the stationary road user to the at least one street lighting device equipped with the Car2X module; and
adapting the lighting of the street lighting devices in the group based on the information received from the stationary road user.

16. The method of claim 12, wherein:
the information detected by the surroundings monitoring system includes surroundings information comprising presence or intensity of precipitation or ambient lighting conditions; and
adapting the lighting comprises adjusting the lighting of the street lighting devices in the group to reduce or prevent blinding of road users based on the surroundings information.

17. The method of claim 12, further comprising:
identifying, based on the information detected by the surroundings monitoring system, a hazard area along the road; and
adapting the lighting of the street lighting devices in the group, whose illuminated areas contain the hazard area, to highlight the hazard area.

18. The method of claim 12, further comprising:
relaying, by the at least one street lighting device equipped with the Car2X module, the received information to an evaluation unit;
statistically evaluating, by the evaluation unit, the relayed information; and
optimizing the adaptation of the lighting of the street lighting devices in the group based on the statistical evaluation.

19. The method of claim 12, further comprising:
receiving, by the at least one street lighting device equipped with the Car2X module, additional traffic-related information from an external data source; and
adapting the lighting of the street lighting devices in the group based on the additional traffic-related information.

20. The method of claim 12, wherein:
the information received from the at least one approaching vehicle includes data regarding lighting characteristics or geometry of the at least one approaching vehicle; and
adapting the lighting comprises adjusting the lighting of the street lighting devices in the group based on the lighting characteristics or geometry of the at least one approaching vehicle.

21. The method of claim 12, further comprising:
transmitting, by the at least one street lighting device equipped with the Car2X module, the received information to one or more other vehicles equipped with Car2X modules or to a street lighting device equipped with a Car2X module in another group of street lighting devices.

22. A lighting control system for situation-based activation of lighting, comprising:
a plurality of Car2X modules configured to be coupled to respective street lighting devices that illuminate a traffic space, wherein at least one Car2X module of the plurality of Car2X modules is configured to receive information from at least one approaching vehicle equipped with a Car2X module, the information comprising data detected by a surroundings monitoring system of the at least one approaching vehicle; and
a control unit communicatively coupled to the plurality of Car2X modules and configured to individually adapt, based on the information received by the at least one Car2X module, the lighting of each respective street lighting device to road users or objects not equipped with Car2X modules.

23. The lighting control system of claim 22, wherein the control unit is configured to:
receive, via the at least one Car2X module, information identifying particularly vulnerable road users detected by the surroundings monitoring system of the at least one approaching vehicle; and
adapt the lighting of the respective street lighting devices, whose illuminated areas contain or intersect with the presence or movement of the particularly vulnerable road users, to enhance visibility of the particularly vulnerable road users.

24. The lighting control system of claim 22, wherein the control unit is configured to:
estimate, based on the information detected by the surroundings monitoring system of the at least one approaching vehicle, a likely movement direction or a likely movement speed of a road user or object not equipped with a Car2X module; and
adapt the lighting of the respective street lighting devices based on the estimated likely movement direction or likely movement speed.

25. The lighting control system of claim 22, wherein:
the at least one Car2X module is further configured to receive information detected by a surroundings monitoring system of a stationary road user equipped with a Car2X module; and
the control unit is configured to adapt the lighting of the respective street lighting devices based on the information received from the stationary road user.

26. The lighting control system of claim 22, wherein:
the information detected by the surroundings monitoring system includes surroundings information comprising presence or intensity of precipitation or ambient lighting conditions; and
the control unit is configured to adjust the lighting of the respective street lighting devices to reduce or prevent blinding of road users based on the surroundings information.

27. The lighting control system of claim 22, wherein the control unit is configured to:
identify, based on the information detected by the surroundings monitoring system, a hazard area within the traffic space; and
adapt the lighting of the respective street lighting devices, whose illuminated areas contain the hazard area, to highlight the hazard area.

28. The lighting control system of claim 22, further comprising an evaluation unit communicatively coupled to the at least one Car2X module, wherein:
the at least one Car2X module is configured to relay the received information to the evaluation unit; and
the evaluation unit is configured to statistically evaluate the relayed information and optimize the adaptation of the lighting of the respective street lighting devices based on the statistical evaluation.

29. The lighting control system of claim 22, wherein:
the at least one Car2X module is configured to receive additional traffic-related information from an external data source; and
the control unit is configured to adapt the lighting of the respective street lighting devices based on the additional traffic-related information.

30. The lighting control system of claim 22, wherein:
the information received from the at least one approaching vehicle includes data regarding lighting characteristics or geometry of the at least one approaching vehicle; and
the control unit is configured to adjust the lighting of the respective street lighting devices based on the lighting characteristics or geometry of the at least one approaching vehicle.

31. The lighting control system of claim 22, wherein:
the at least one Car2X module is configured to transmit the received information to one or more other vehicles equipped with Car2X modules or to a Car2X module in another plurality of Car2X modules coupled to respective street lighting devices.
